(19) United States
(12) Patent Application Publication
(10) Pub. No.: US 2012/0145878 A1
(43) Pub. Date: Jun. 14, 2012

(54) MULTI-PURPOSE POSITIONABLE SUPPORT FOR ACCESSORIES SUCH AS PORTABLE DIGITAL DEVICES

(76) Inventor: Brian Michael Zoll, Owosso, MI (US)

(21) Appl. No.: 13/325,676

(22) Filed: Dec. 14, 2011

Related U.S. Application Data
(60) Provisional application No. 61/459,539, filed on Dec. 14, 2010.

(51) Int. Cl. F16M 11/22

(52) U.S. Cl. 248/688

(57) ABSTRACT

An accessory support device includes a carriage unit and a plurality of manually bendable leg assemblies. Each leg assembly includes an inner section, a middle section, and outer section, with the sections being interconnected by pivot joints. The pivot joints are bendable by hand and substantially retain the position to which they are bent.

### CROSS-REFERENCE TO RELATED APPLICATIONS

This utility patent application claims the benefit of U.S. Provisional Patent Application Ser. No. 61/459,539, filed Dec. 14, 2010, the entire content of which is incorporated herein by reference.

### FIELD OF THE INVENTION

The present invention relates generally to adjustable positionable supports for accessories such as digital devices, cameras and other objects.

### BACKGROUND OF THE INVENTION

There has been a proliferation of portable accessories such as smart phones, tablets, cameras of various sizes, portable music and video players, gaming systems and the like. While all of these accessories may be handheld during use, it is often desirable to support them for viewing, data entry, picture taking, and other tasks. Devices such as camera tripods allow a camera to be positioned above the flat surface with its position being adjusted by adjusting the length or angle of the tripod legs. While useful, such a tripod is a special purpose device and is not well suited to supporting other accessories, or supporting any accessory in more complex positions. Other devices, such as reading supports for tablet computers, allow an accessory device to be supported on a flat surface and angled for viewing during reading or watching of a video. Again, such devices are useful, but their use is limited to specific accessories and situations. There is a need for multi-purpose support devices that are capable of achieving a plurality of positions for an accessory being supported by the support device.

### SUMMARY OF THE INVENTION

The present invention provides a multi-purpose accessory support device that may be positioned in a plurality of positions and which is manually manipulable into the plurality of positions and substantially retains the position into which it is manually manipulated. Embodiments of the present invention may take a variety of forms.

According to one embodiment, an accessory support device is designed for supporting an accessory in a stationary position with respect to a surface. The device includes a carriage unit having a perimeter surrounding a central portion. The carriage unit has an accessory face for supporting an accessory. The carriage unit generally lies in and defines a carriage plane. The device has a plurality of manually bendable leg assemblies, with each leg assembly having a proximal end attached to the carriage unit and a distal end for contacting a surface. Each leg assembly includes an inner section defining the proximal end of the leg assembly and a first pivot joint defining a first pivot axis. The first pivot joint interconnects the inner section with a carriage unit such that the inner section is pivotable about the first pivot axis to a plurality of positions with respect to the carriage unit. Each leg unit further includes a middle section and a second pivot joint defining a second pivot axis. The second pivot joint interconnects the middle section with the inner section such that the middle section is pivotable about the second pivot axis to a plurality of positions with respect to the inner section. Each leg assembly also has an outer section defining the distal end of the leg assembly and a third pivot joint defining a third pivot axis. The third pivot joint interconnects the outer section with the middle section such that the outer section is pivotable about the third axis to a plurality of positions with respect to the middle section. Each of the pivot joints is a one degree of freedom joint. The first pivot axis is generally perpendicular to the carriage plane and the second and third axes are each generally parallel to the carriage plane. Each of the pivot joints is bendable by hand and substantially retains a position to which it is bent such that the leg assemblies substantially retain any of a plurality of positions to which they are bent.

### BRIEF DESCRIPTION OF THE DRAWINGS

FIG. 1 is a perspective view a first embodiment of an accessory support device in accordance with the present invention.

FIG. 2 is a bottom view of the accessory support device of FIG. 1;

FIG. 3 is a front view of the accessory support device of FIGS. 1 and 2;

FIG. 4 is an exploded view of a portion of an accessory support device in accordance with an embodiment of the present invention;

FIG. 5 is an exploded perspective view of a leg assembly for use with some embodiments of the present invention;

FIG. 6 is a top view of the leg assembly of FIG. 5;

FIG. 7 is a top view of a carriage unit and a portion of a leg assembly showing a range of motion for the leg assembly;

FIG. 8 is a top view similar to FIG. 7 showing a different leg assembly and the range of motion for this leg assembly;

FIG. 9 is a view of a leg assembly showing the range of motion for the outer section of the leg assembly;

FIG. 10 is a view of a portion of a leg assembly showing the range of motion of a middle section of a leg assembly;

FIG. 11 is a side view of a portion of an accessory support device in accordance with the present invention with elements of a gripping assembly separated so as to show the components;

FIG. 12 is a view of the components of an embodiment of a gripping assembly that forms part of some embodiments of the present invention;

FIG. 13 is a perspective view of an embodiment of an accessory support device in accordance with the present invention supporting a tablet computing device;

FIG. 14 is a view of an embodiment of an accessory support device in accordance with the present invention with the leg assemblies folded into a compact position;

FIG. 15 is a perspective view of an outer leg section of a leg assembly;

FIG. 16 is a perspective view of an optional covering for an outer leg section of a leg assembly;

FIG. 17 is a side view of another alternative outer leg section of a leg assembly;

FIG. 18 is a perspective view of coupling member that forms part of the leg assembly of FIG. 17;

FIG. 19A is a perspective view of an end piece connected to the coupling member of FIG. 18, both of which may be attached to the leg section of FIG. 17;

FIG. 19B is a perspective view of an alternative end piece connected to the coupling member of FIG. 18, both of which may be connected to the leg section of FIG. 17;

FIG. 19C is a perspective view of another alternative end piece connected to the coupling member of FIG. 18, both of which may be connected to the leg section of FIG. 17;

FIG. 20A is a perspective view of a further alternative end piece which may be connected to the coupling member of FIG. 18 for connection to a leg section;

FIG. 20B is a perspective view of the end piece of FIG. 20A coupled to the coupling member of FIG. 18 along with an adapter adaptor for connection thereto;

FIG. 20C is a perspective view similar to FIG. 20B with an alternative adapter piece;

FIG. 20D is a perspective view similar to FIGS. 20B and 20C with yet another alternative adapter piece;

FIG. 21A is a perspective view of an alternative member for forming part of a gripping assembly;

FIG. 21B is a side view of the member of FIG. 21A in a folded position;

FIG. 21C is a side view of the member of FIGS. 21A and 21B and in unfolded position;

FIG. 22 is a top view of an alternative carriage unit that may form part of some embodiments of the present invention;

FIG. 23 is a perspective view of an alternative embodiment of an accessory support device in accordance with the present invention, utilizing the member of FIGS. 21A-21C and the carriage unit of FIG. 22; and

FIG. 24 is a perspective view of the accessory support device of FIG. 23 with the folding member of the gripping assembly extended so as to support a tablet device.

### DETAILED DESCRIPTION OF THE PREFERRED EMBODIMENTS

The present invention provides various embodiments of an accessory support device that has a carriage unit for supporting an accessory and a plurality of manually bendable leg assemblies. Some embodiments of the present invention are designed for use with a plurality of different accessories, such as cameras, smart phones and tablets, while other embodiments may be dedicated to more specific uses. While each embodiment includes a plurality of leg assemblies, the number of leg assemblies may vary. Most embodiments include three or more legs, with some including six leg assemblies arranged in opposed pairs. The plurality of manually bendable leg assemblies allow the accessory support device to be manipulated into a plurality of positions. The pivot joints in the leg assemblies are bendable by hand and substantially retain a position to which they are bent such that each leg assembly substantially retains any of a plurality of positions to which it is bent. The accessory support device may then be repositioned by manually bending the leg assemblies into other positions, including a compact storage position.

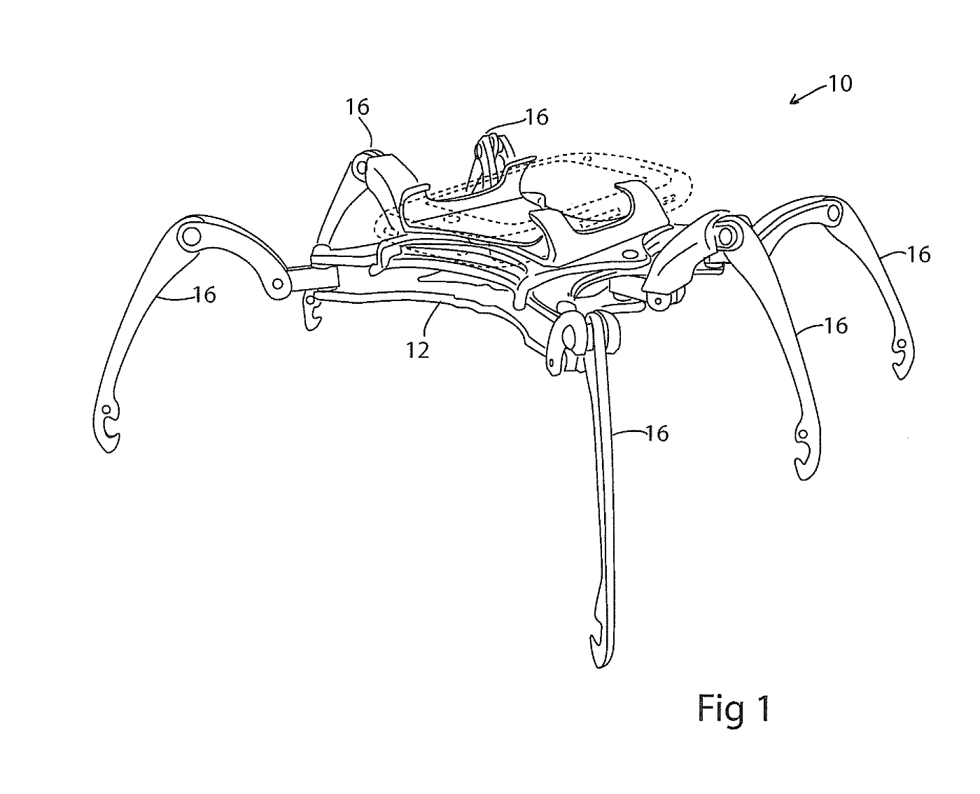

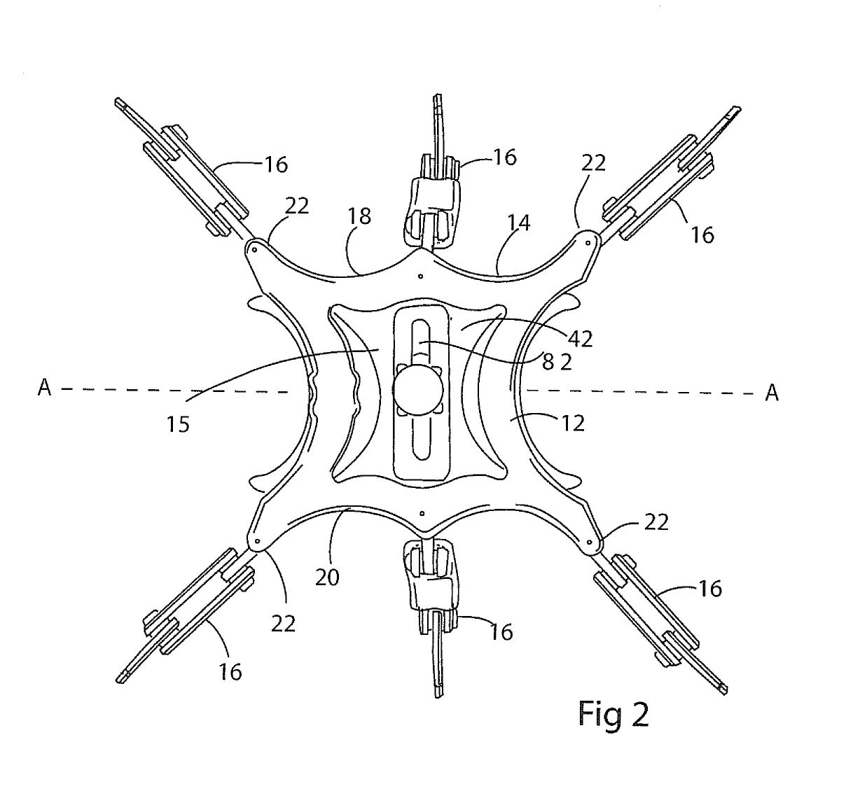

Referring to FIGS. 1-3, a first embodiment of an accessory support device in accordance with the present invention is generally shown at 10. The device has a carriage unit 12 which, in this embodiment, it is generally flat and may be said to generally lie in and define a carriage plane. Carriage unit 12 may be said to have a perimeter 14 surrounding a central portion 15, best seen in the bottom view of FIG. 2. The “perimeter,” as used herein, is the area adjacent of the outermost edge of the carriage unit. In the embodiment of FIGS. 1-3, a plurality of leg assemblies 16 may be said to be connected to the perimeter 14 of the carriage unit 12. In other embodiments, the leg assemblies may be connected in other ways. In the illustrated embodiment, the device 10 has six leg assemblies 16 which are substantially identical to one another. In other embodiments, the leg assemblies may not be identical to one another.

Referring to FIG. 2, the carriage unit 12 may be said to have opposed sides 18 and 20, with three leg assemblies 16 interconnected with each of these opposed sides. The leg assemblies in this embodiment are arranged in opposed pairs along the opposed sides 18 and 20. Four of the leg assemblies may be said to be interconnected with corners 22 of the carriage unit 12. Two of the leg assemblies are interconnected to the sides 18 and 20 in-between the corners 22. As shown, the carriage unit 12 and the leg assemblies 16 are arranged generally symmetrically with respect to a centerline A-A defined intermediate the opposed sides 18 and 20.

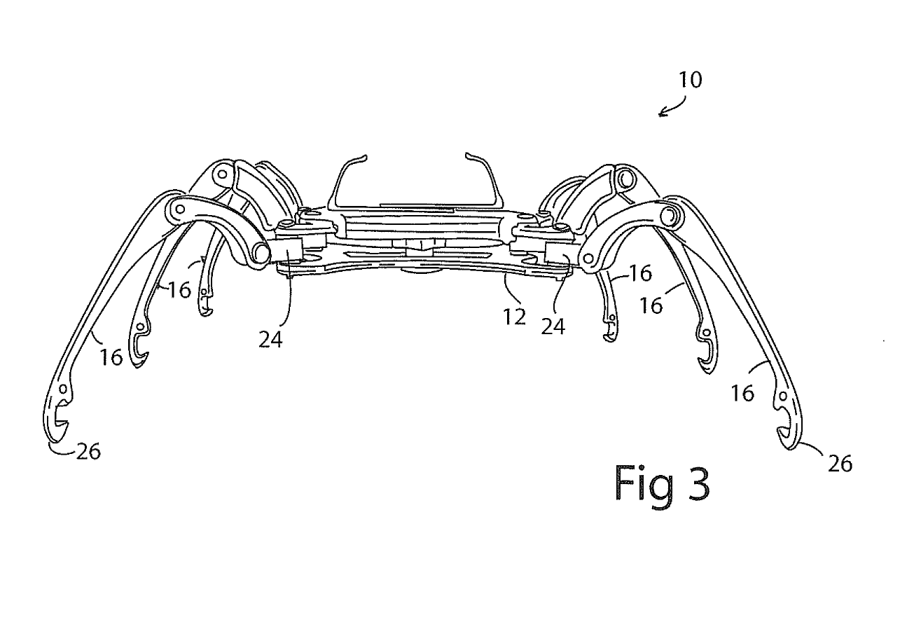

Referring to FIG. 3, each of the leg assemblies 16 has a proximal end 24 attached to the carriage unit and a distal end 26 for contacting the surface. The “surface” contacted by the distal ends may be any variety of surfaces, including a floor, a desk, or a surface of a complex object such as the dashboard of a car or an arm or back of a piece of furniture. As will be clear with those of skill in the art, the device 10 is capable of supporting an accessory with only some of the leg assembly 16 contacting the surface.

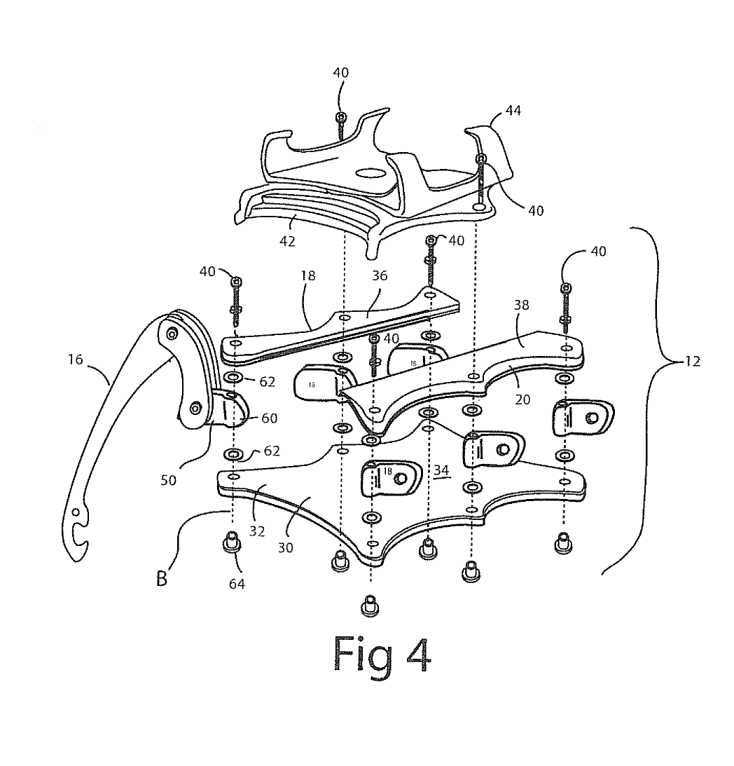

Referring now to FIG. 4, an embodiment of the carriage unit 12 will be discussed in more detail. As will be clear to those of skill in the art, the carriage unit may take a variety of forms. In this embodiment, the carriage unit includes a bottom plate 30 with a perimeter 32 surrounding a central area 34. This plate 30 generally defines the width and perimeter shape of the carriage unit 12. Upper plate members 36 and 38 define opposed side edges 18 and 20 of the carriage unit 12 and are interconnected with the corresponding side edges of the bottom plate 30 by a plurality of fasteners 40. A central member 42 bridges a gap between the upper members 36 and 38 and is interconnected with the remainder of the carriage unit 12 using some of the fasteners. In this embodiment, a gripping assembly 44 is interconnected with the carriage unit 12 by being interconnected with the central member 42.

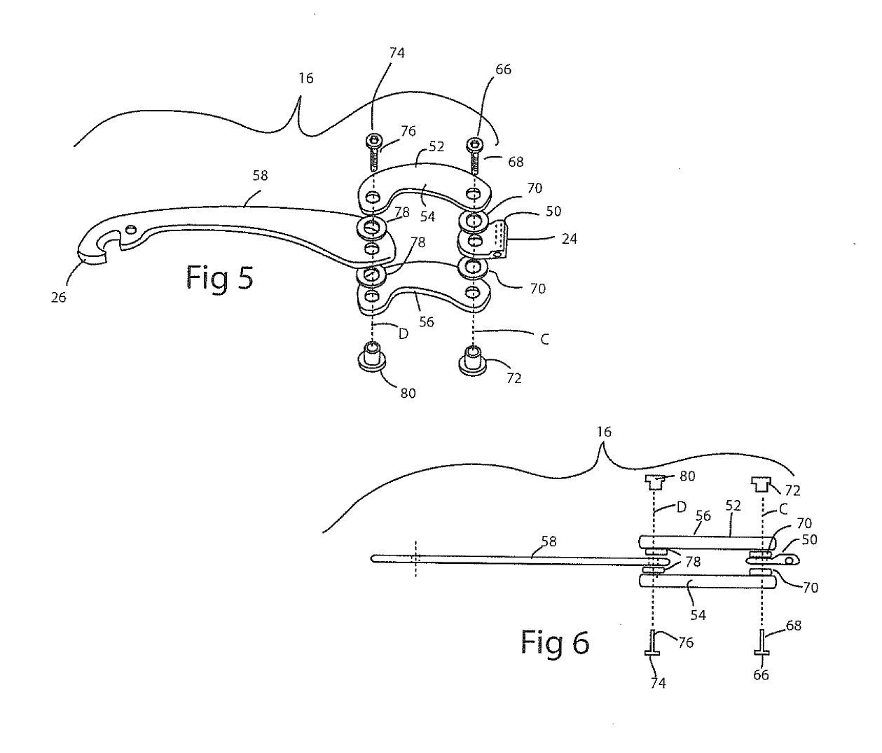

Referring now to FIGS. 5 and 6, a leg assembly 16 will be described in more detail. In this embodiment, the leg assemblies were substantially identical, so only one leg assembly is illustrated and described. Each leg assembly includes an inner section 50 that defines the proximal end 24 of the leg assembly 16. Each leg assembly further has a middle section 52, which in this embodiment is formed by a pair of side plates 54 and 56. An outer section 58 defines the distal end 26 of the leg assembly 16. Referring again to FIG. 4, the inner section 50 of each leg assembly 16 is interconnected with the carriage unit 12 by a first pivot joint 60. The first pivot joint defines a first pivot axis B. The pivot joint 60, in this embodiment, is defined by a fastener 40, a pair of nylon washers 62 and a nut 64. The first pivot joint 60 is a one degree of freedom joint that allows the inner section 50 to pivot around the first pivot axis B to a plurality of positions with respect to the carriage unit 12. The pivot axis B is generally perpendicular to a carriage plane defined by the carriage unit 12. Referring again to FIGS. 5 and 6, the middle section 52 is interconnected with the inner section 50 by a second pivot joint 66. The second pivot joint 66 is defined by a fastener 68, a pair of nylon washers 70, and a nut 72. The second pivot joint defines a second pivot axis C. The outer section 58 is interconnected with the middle section 52 by a third pivot joint 74, which is defined by a fastener 76, a pair of nylon washers 78, and a nut 80. The third pivot joint 74 defines a third pivot axis D. As will be clear with reference to FIGS. 4-6, the second and third pivot axis, C and D, are generally perpendicular to the pivot axis B and parallel to the carriage plane defined by the carriage unit 12. Like the first pivot joint, the second and third pivot joint 66 and 74 are one degree of freedom joints. The middle section is pivotable about the second pivot axis to a plurality of positions with respect to the inner section 50. The outer section 58 is pivotable about the third pivot axis D to a plurality of positions with respect to the middle section 52. The pivot joints 60, 66 and 74 preferably place the nylon washers 62, 70 and 78 in compression so as to provide a friction joint that is bendable by hand but substantially retains the leg sections in any of the plurality of positions to which they are bent by hand, until they are bent to a further position by hand. As will be clear to those of skill in the art, the pivot joints may be formed in ways other than illustrated while still providing the described function. As shown in FIG. 5, the length of the inner section 50 is less than the length of the middle section 52, which is less than the length of the outer section 58. In each case, the length is defined as the shortest distance between the pivot axes defined by the pivot joints. This arrangement of leg section lengths is preferred for some embodiments, but may be altered in others.

Referring again to FIG. 4, in the illustrated embodiment the inner sections 50 of the leg assembly 16 are each interconnected with the carriage unit 12 by being captured between the bottom plate 30 and one of the upper plate members 36 or 38. As will be clear to those of skill in the art, the leg assemblies may be attached in other ways.

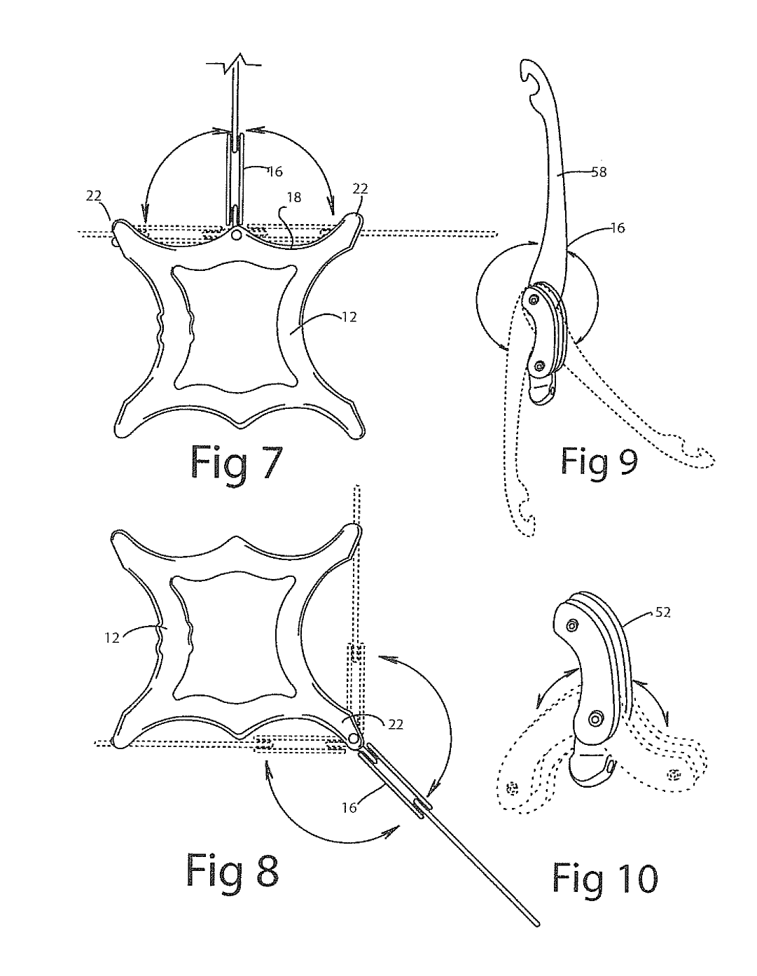

Referring now to FIG. 7, a portion of a carriage unit 12 is illustrated along with a portion of a leg assembly 16 attached to the side 18 intermediate two of the corners 22. This Figure illustrates that the leg assembly 16 may be pivoted around the first pivot axis through a range of approximately 180 degrees. The illustrated leg assembly may be considered a side leg assembly. FIG. 18 provides a similar view for a leg assembly 16 attached to a corner 22 of the carriage unit 12. As shown, the leg assembly 16 may pivot through approximately 270 degrees. This leg assembly may be considered a corner leg assembly.

Referring to FIG. 9, leg assembly 16 is illustrated with the outer section 58 illustrated in a fully extended position in solid lines and in two fully pivoted positions, with respect to the middle section 52, in phantom lines. FIG. 10 provides a similar view for the middle section 52, illustrating it in an extended position in solid lines and in pivoted positions in phantom lines.

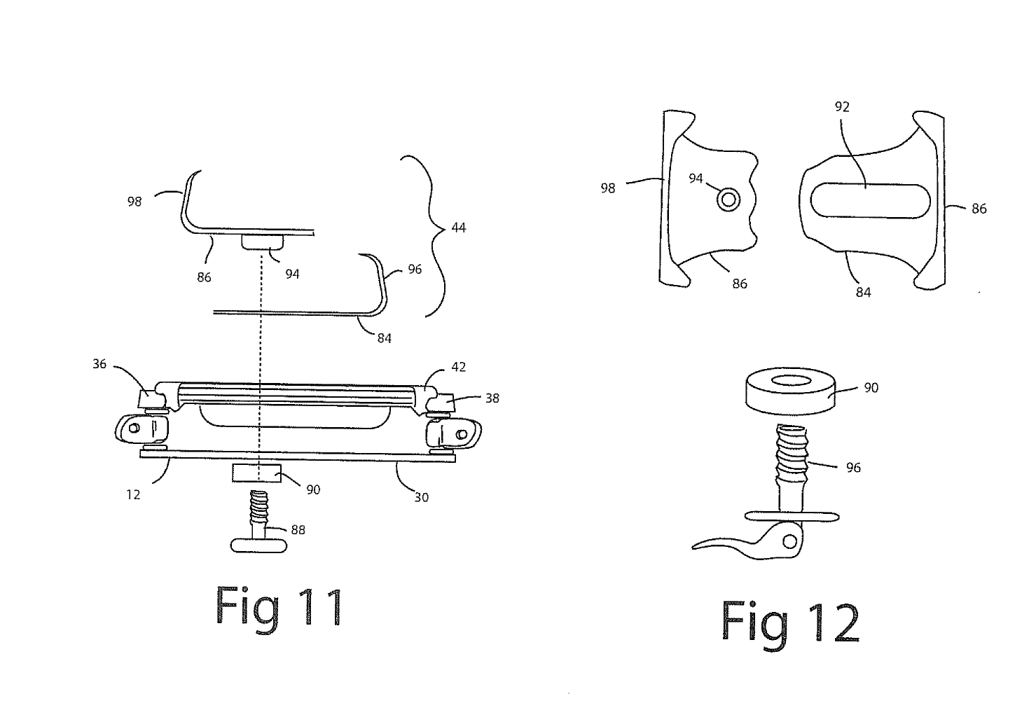

Referring now to FIG. 11, an end view is provided of a portion of a carriage unit 12, showing the central member 42 extending between and interconnecting the upper plate members 36 and 38. Referring back to FIG. 2, the bottom view is provided in which the central member 42 is shown. As illustrated, the central member 42 has an elongated slot 82. Referring again to FIG. 11, a gripping assembly 44 is formed by a first member 84 and an opposed second member 86 which are slidably interconnected with one another and slidably interconnected with a slot 82 in the central member 42. The gripping assembly 44 may be interconnected with the carriage unit by a fastener 88 that extends through the slot 82 and the central member 42 and engages the second gripping member 82. A spacer 90 may be provided. The spacer 90 may fit into a depression around the slot 82 (see FIG. 4) when supporting a camera. The fastener 88 may also be used to engage an accessory such as a camera that has a receiving hole designed for such a fastener, thereby attaching the camera to the carriage unit 12. FIG. 12 provides a top view of the first gripping member 84 and second gripping member 86. In this embodiment, the first gripping member 84 has a slot 92 defined therein and the second gripping member 86 has a receiving nut 94 disposed therein for receiving the fastener. FIG. 12 illustrates an alternative fastener 96 that includes a thumb lock portion for quickly tightening and loosening the gripping members 84 and 86 with respect to each other and with respect to the central member 42. In this embodiment, the gripping members 84 and 86 each have an upwardly extending flange, 96 and 98 respectively. These flanges 96 and 98 may extend upwardly and somewhat inwardly so as to provide a concave inner surface. As is clear to those of skill in the art, by adjusting the relative position of the gripping members 84 and 86, a variety of accessories may be gripped between the gripping members. Referring back to FIG. 1, one such accessory is illustrated in phantom lines.

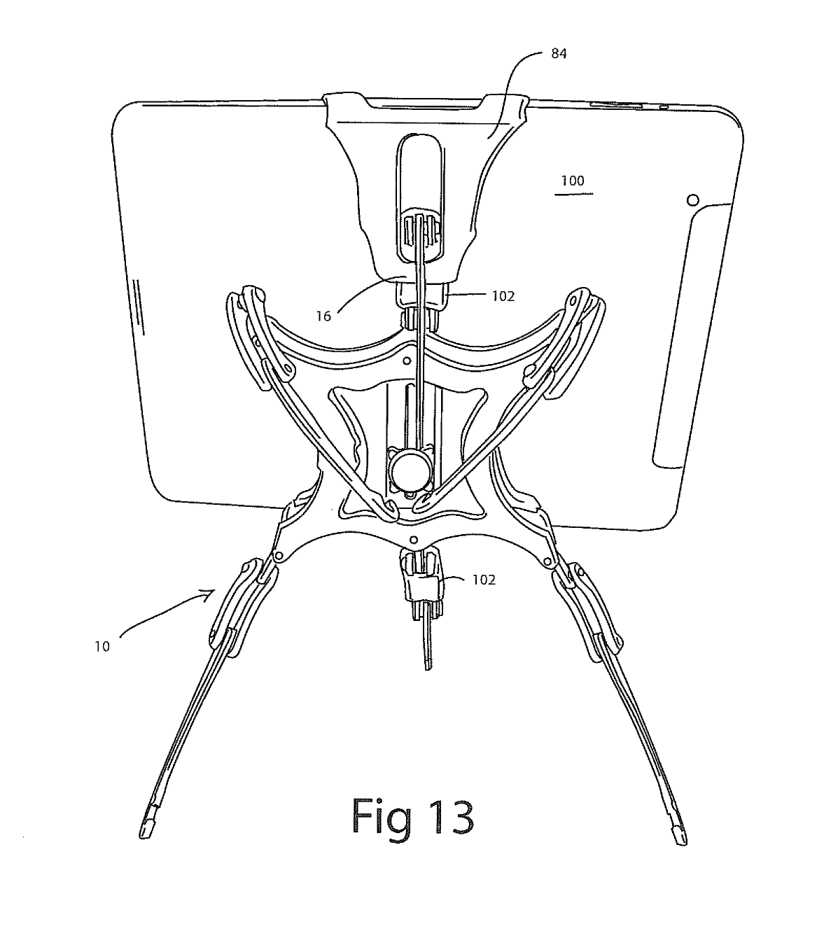

As an alternative, the second gripping member 86 may be interconnected with central member 42 while the first gripping member 84 is removed therefrom. The second gripping member 84 may then be hooked over one of the leg assemblies 16 as shown in FIG. 13. This allows the device 10 to support a larger accessory such as tablet 100. FIG. 13 also illustrates one of the many positions into which the bendable leg assemblies may be moved such that the support device 10 can support an accessory. FIG. 13 also illustrates a pair of optional polymer bumpers 102 which are disposed around the middle sections of the two side leg assemblies. These bumpers 102 may help to provide a cushion surface for the accessory 100 and help in positioning the gripping member 84. Additional bumpers may be provided, or the bumpers may take other forms.

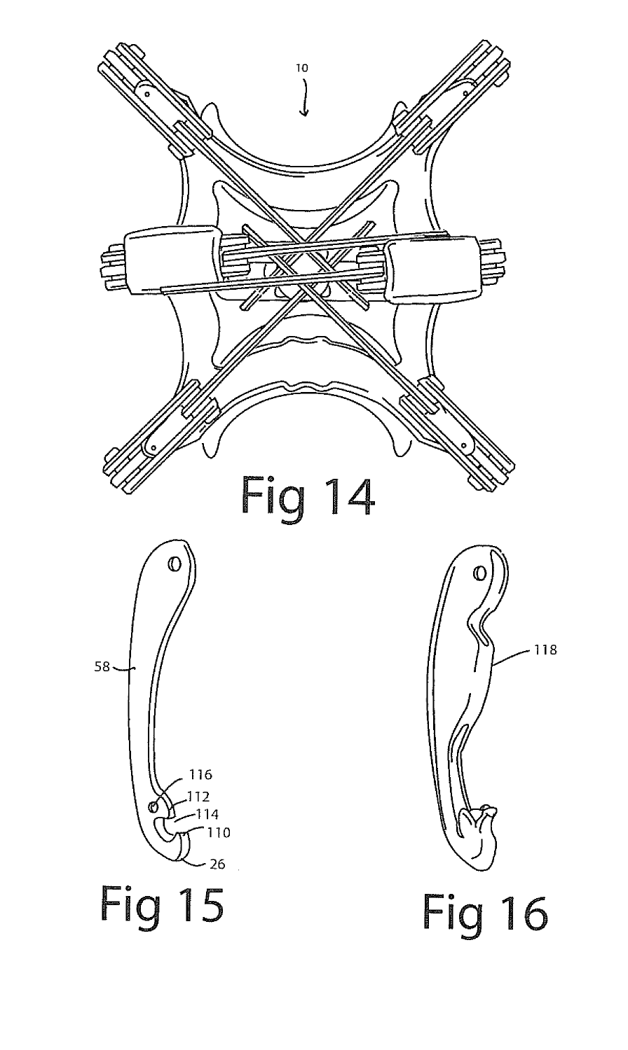

Referring now to FIG. 14, an accessory support device 10 in accordance with the present invention is shown with the leg assemblies all folded inwardly into a compact storage position. This further illustrates one of the plurality of positions into which the leg assemblies may be moved.

Referring now to FIG. 15, an outer section 58 of the leg assemblies is illustrated. In this embodiment, the distal end 26, which is defined by one end of the outer section 58, is hook shaped. Specifically, it has a hooked end 110 with a tip of the hook extending generally back towards the remainder of the outer section 58. In this embodiment, the end also has a counter hook 112 spaced from the hook end 110 so as to define a gap 114. The gap takes the form of a concave mouth. This shape allows the end 26 of the outer section 58 to rest on a surface or grip a variety of elements for retaining the support device relative thereto. In this embodiment, the outer section also has an opening 116 defined therethru, which may be used for attaching other elements thereto or attaching the outer section to other elements. FIG. 16 illustrates an optional sleeve 118 which may cover the outer section 58. Similar covers may be provided for other sections. In some embodiments, the outer section 58 is formed of metal and in some embodiments the outer section 118 is molded from a polymer or is metal with a polymer coating.

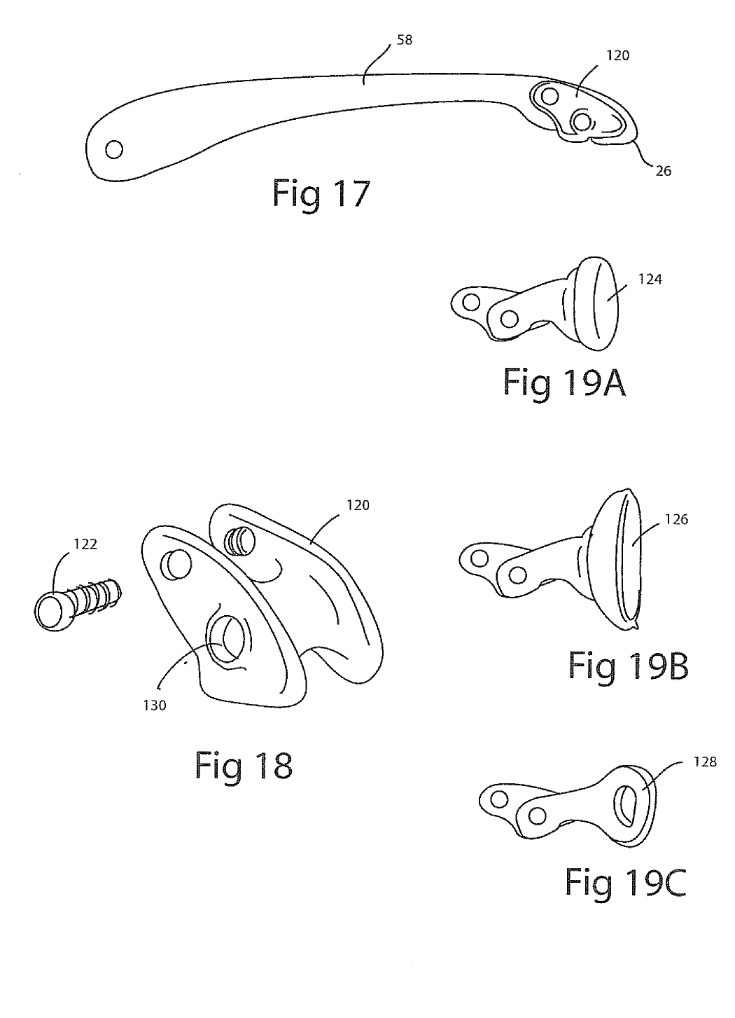

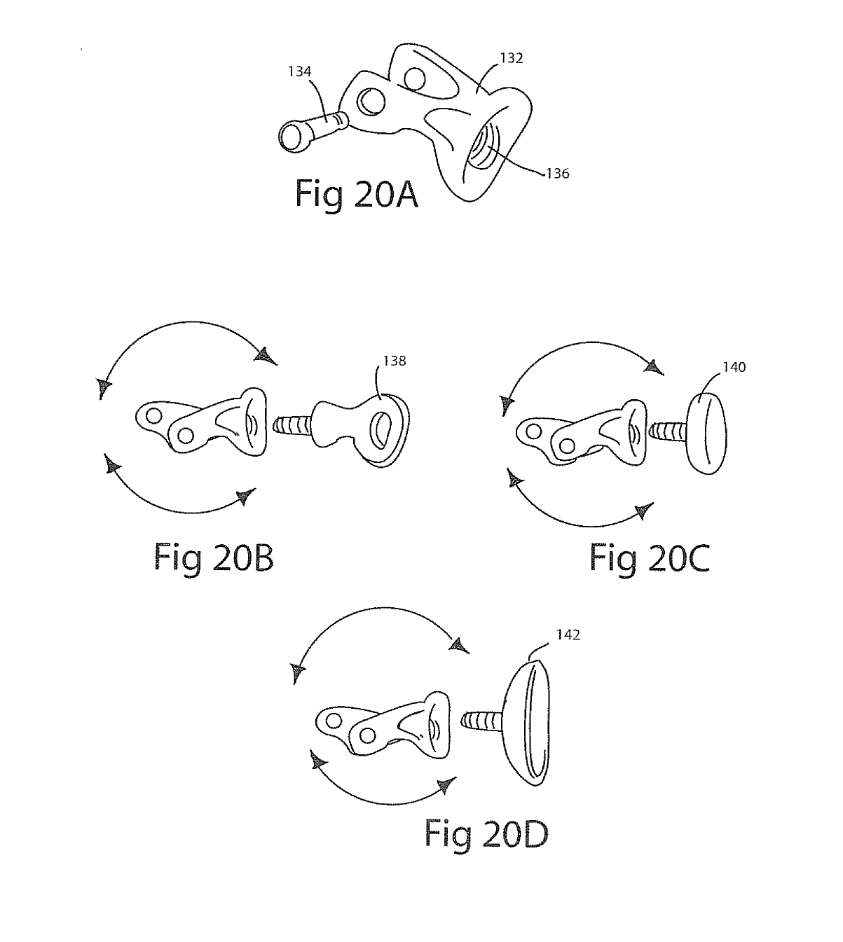

Referring now to FIG. 17, an outer section 58 is again illustrated, but this time with a coupling member 120 interconnected with the distal end 26. The coupling member 120 is illustrated in more detail in FIG. 18. The coupling member 120 is received into the hook feature and is retained in place by a fastener 122 that passes through the opening 116. The coupling member may take other forms, may engage with the outer section 58 in other ways, or be fastened thereto in other ways. FIGS. 19A-19C illustrate three alternative end pieces 124, 126 and 128 that may be connected to the outer section 58 of a leg assembly by being connected to the coupling member 120, which in turn is connected to the outer section 58. An opening 130 is provided in the coupling member for attaching the end pieces thereto. The end piece 124 is a magnet, the end piece 126 is a suction cup, and the end piece 128 is an eyelet. Such end pieces may be useful in a variety of applications. FIG. 20A illustrates a further alternative end piece 132 which interconnects with the coupling member 120 using a fastener 134. The end piece 132 has a threaded receiving port 136 defined therein. FIGS. 20B-20D illustrates the end piece 132 in combination with adapter pieces 138, 140 and 142. The adapter pieces 138-142 may be threaded into the threaded receiving port 136 and interchanged so as to provide various features.

As will be clear to those with skill in the art, the adapter pieces and the end pieces may take other forms depending on how the accessory support device is to be used.

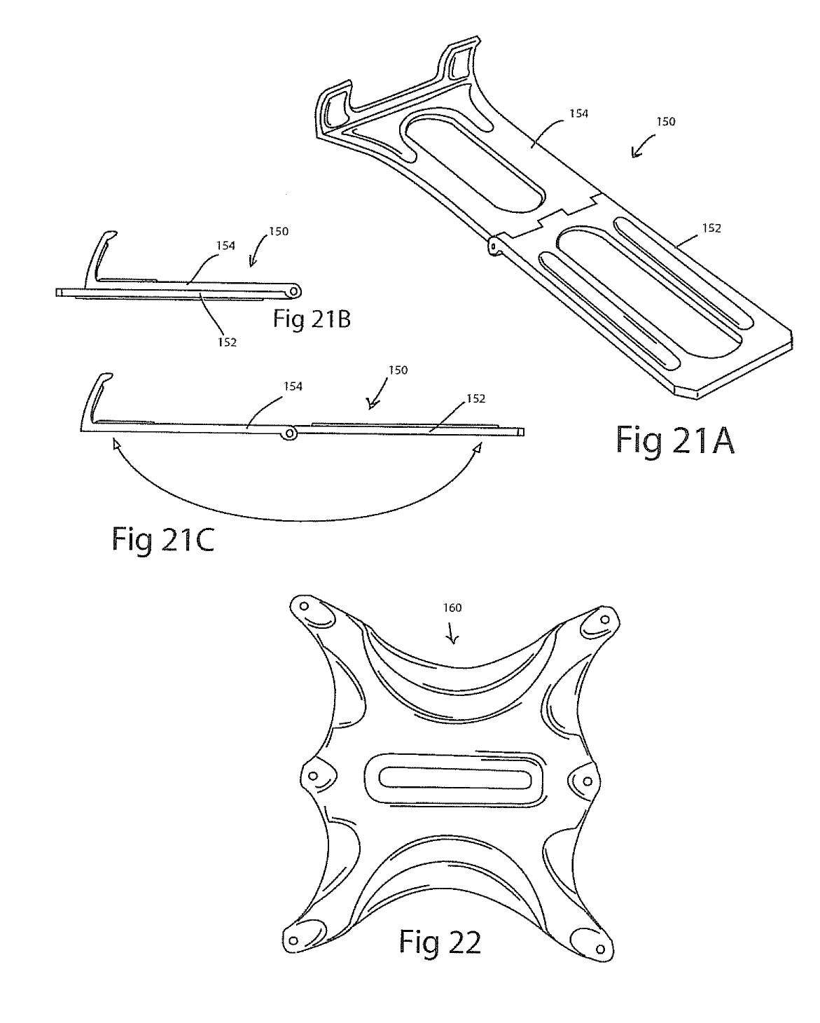

Referring now to FIGS. 21A-21C, an alternative gripping member is shown at 150. This gripping member 150 may replace one of the gripping members of the gripping assembly of FIGS. 11 and 12. The gripping member 150 has a first piece 152 and a second piece 154 that are pivotally interconnected. FIGS. 21A and 21C show the gripping member 150 in an unfolded or extended position while FIG. 21B shows the gripping member 150 in a folded position.

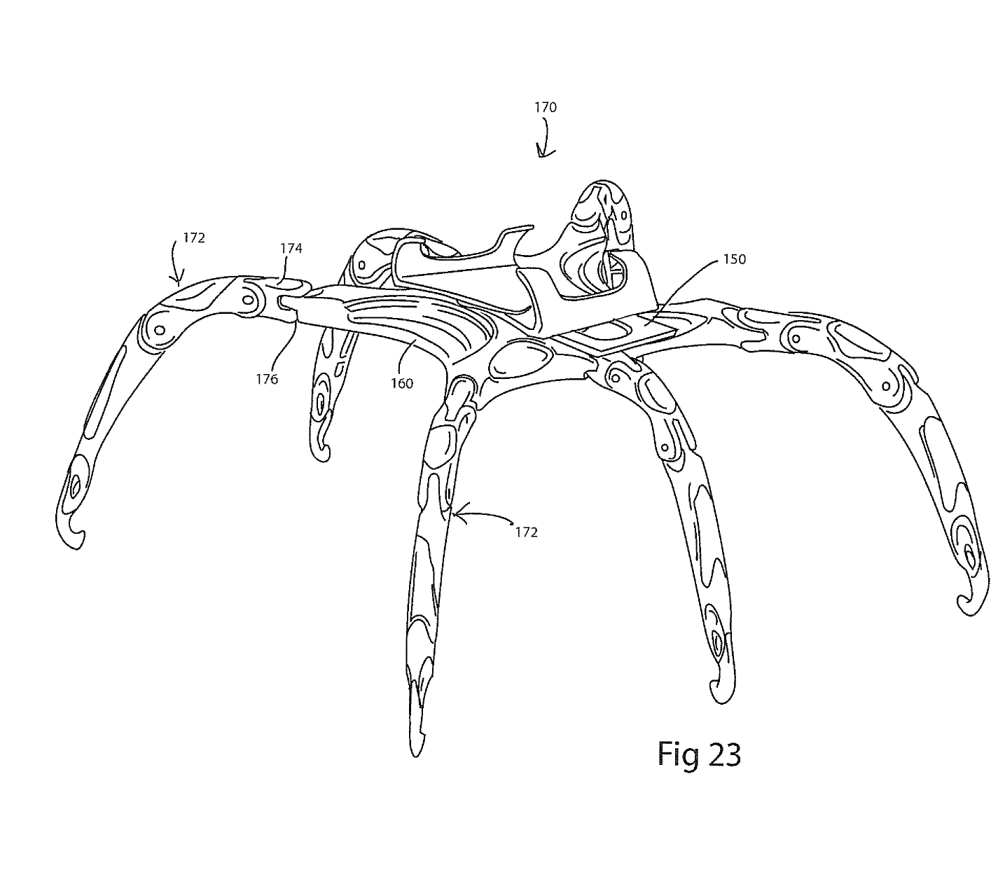

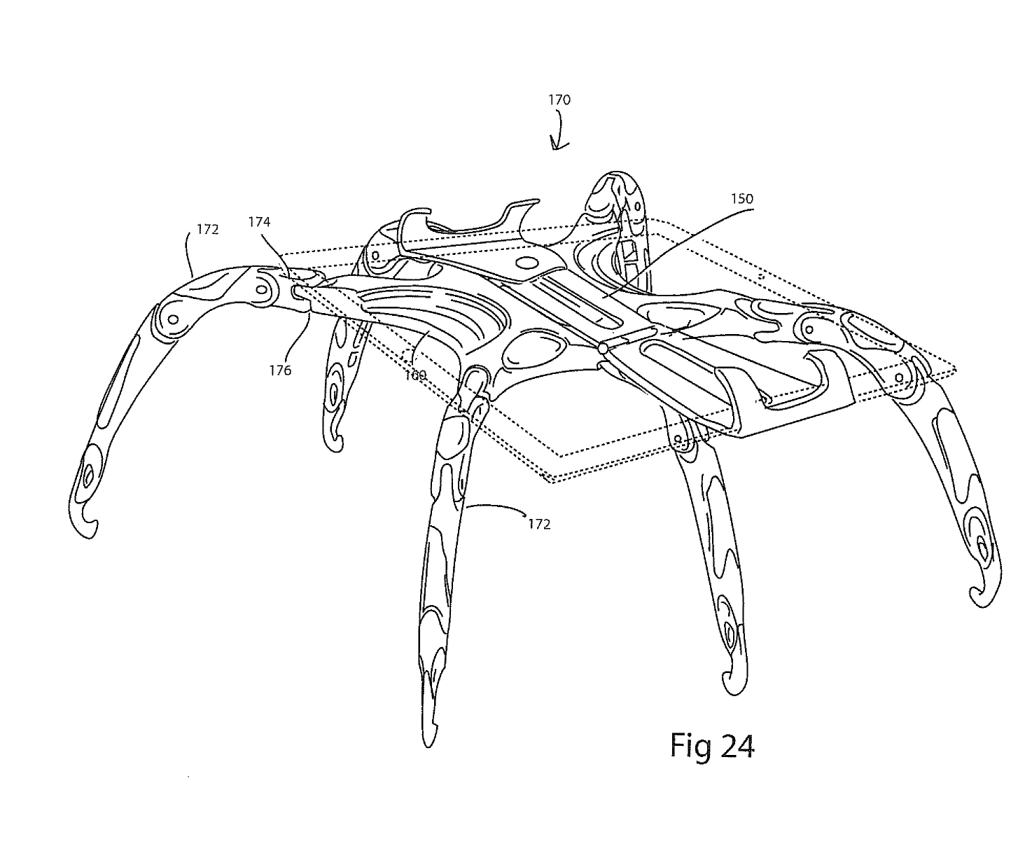

Referring now to FIG. 22, an alternative carriage unit is shown at 160. In this embodiment, the carriage unit is a unitary piece that may be formed such as by molding. It is simpler than the version of FIG. 4. FIG. 23 illustrates an alternative embodiment of an accessory support device in accordance with the present invention, utilizing the carriage unit 160 and the alternative gripping member 150. The alternative accessory support device 170 also has alternative leg assemblies 172. These leg assemblies 172 are similar to the leg assemblies 16 in the arrangement of the pivot axis with respect to the carriage unit 160 but may be formed by molding rather than of individual metal pieces. As with the earlier embodiment, the leg assemblies preferably include pivot joints with nylon washers to allow manual bending and retaining of a position. Unlike the earlier embodiment, the inner section 174 leg assembly forms a mouth 176 at its inner end with a portion of the perimeter of the carriage unit 160 being captured in this mouth 176. FIG. 24 illustrates the accessory support device of FIG. 23 with the gripping member 150 folded to its extended position, with the accessory support device supporting a larger accessory 180.

A support device in accordance with the present invention may take other forms. In one example, the carriage until takes the form of a case for an accessory, with the leg assemblies attached thereto. In one version, the carriage unit is formed as a case for a smart phone with the leg assemblies attached to its perimeter or its underside. The leg assemblies may be quickly attached and detached, either individually or as a group, in some versions. In a further example, a support device has three or four leg assemblies, arranged so as to support a carriage unit with respect to a variety of surfaces. In yet a further example, the one-degree of freedom joint between the leg assemblies and the carriage unit, such as 60 in FIG. 4, may be replaced with a joint with more degrees of freedom, such as a ball joint. The other joints may also be replaced with other joint types, for certain applications.

As will be clear to those of skill in the art, the herein described and illustrated embodiments of the present invention may take other forms without departing from the scope or teaching of the present invention. It is the following claims, including all equivalents, which define the scope of the present invention.

1. An accessory support device for supporting an accessory in a stationary position with respect to a surface, the device comprising:
a carriage unit having a perimeter surrounding a central portion, the carriage unit having an accessory face for supporting an accessory, the carriage unit generally lying in and defining a carriage plane;
a plurality of manually bendable leg assemblies, each leg assembly having a proximal end attached to the carriage unit and a distal end for contacting a surface, each leg assembly comprising:
an inner section defining the proximal end of the leg assembly;
a first pivot joint defining a first pivot axis, the first pivot joint interconnecting the inner section with the carriage unit such that the inner section is pivotable about the first pivot axis to a plurality of positions with respect to the carriage unit;
a middle section;
a second pivot joint defining a second pivot axis, the second pivot joint interconnecting the middle section with the inner section such that the middle section is pivotable about the second pivot axis to a plurality of positions with respect to the inner section;
an outer section defining the distal end of the leg assembly; and
a third pivot joint defining a third pivot axis, the third pivot joint interconnecting the outer section with the middle section such that the outer section is pivotable about the third pivot axis to a plurality of positions with respect to the middle section;
wherein each of the pivot joints is a 1 degree of freedom joint, the first pivot axis being generally perpendicular to the carriage plane and the second and third axes each being generally parallel to the carriage plane;
wherein each of the pivot joints is bendable by hand and substantially retains the position to which it is bent such that the leg assemblies substantially retain any of a plurality of positions to which they are bent.

2. An accessory support device in accordance with claim 1, further comprising:
a gripping assembly to retain an accessory on the carriage unit, the gripping assembly including a first and an opposed second member that each have an upwardly extending flanges, the first and second members being slidable relative to each other such that an accessory may be gripped between the flanges.

3. An accessory support device in accordance with claim 2, wherein:
the carriage unit has a slot defined therein, the gripping assembly being interconnected with the carriage unit by a fastener extending through the slot such that the gripping assembly is adjustably positionable on the carriage unit.

4. An accessory support device in accordance with claim 1, wherein:
the plurality of bendable leg units are substantially identical to one another.

5. An accessory support device in accordance with claim 1, wherein:
the inner section of each of the leg assemblies is shorter than the middle section of each of the leg assemblies.

6. An accessory support device in accordance with claim 5, wherein:
the middle section of each of the leg assemblies is shorter than the outer section of each of the leg assemblies.

7. An accessory support device in accordance with claim 1, wherein:
the proximal ends of each of the leg assemblies are connected to the perimeter of the carriage unit.

8. An accessory support device in accordance with claim 7, wherein:
the leg assemblies are arranged in opposed pairs on opposed sides of the carriage unit.

9. An accessory support device in accordance with claim 8, wherein:
the leg assemblies comprise 3 pairs of opposed leg assemblies.

10. An accessory support device in accordance with claim 1, wherein:
the leg assemblies comprise more than 3 leg assemblies.

11. An accessory support device in accordance with claim 10, wherein:
the leg assemblies comprise 6 leg assemblies.

12. An accessory support device in accordance with claim 1, wherein:
the carriage unit comprises an upper plate and a lower plate with the proximal ends of the leg assemblies being disposed between the upper and lower plates.

13. An accessory support device in accordance with claim 1, wherein:
each of the pivot joints include frictionally engaged polymer elements operable to substantially retain the joints in the positions to which they are bent.

14. An accessory support device in accordance with claim 13, wherein:
each of the pivot joints further comprises an adjustable fastener for adjusting a pressure on the polymer elements.

15. An accessory support device for supporting an accessory in a stationary position with respect to a surface, the device comprising:
a carriage unit having a perimeter surrounding a central portion, the carriage unit having an accessory face for supporting an accessory, the carriage unit generally lying in and defining a carriage plane;
a plurality of manually bendable leg assemblies, each leg assembly having a proximal end attached to the carriage unit and a distal end for contacting a surface, each leg assembly comprising:
an inner section defining the proximal end of the leg assembly;
a first joint interconnecting the inner section with the carriage unit such that the inner section is movable to a plurality of positions with respect to the carriage unit;
a middle section;
a second pivot joint defining a second pivot axis, the second pivot joint interconnecting the middle section with the inner section such that the middle section is pivotable about the second pivot axis to a plurality of positions with respect to the inner section;
an outer section defining the distal end of the leg assembly; and
a third pivot joint defining a third pivot axis, the third pivot joint interconnecting the outer section with the middle section such that the outer section is pivotable about the third pivot axis to a plurality of positions with respect to the middle section;
wherein the second and third axes are each generally parallel to the carriage plane;
wherein each of the joints is bendable by hand and substantially retains the position to which it is bent such that the leg assemblies substantially retain any of a plurality of positions to which they are bent.
